(19) United States
(12) Patent Application Publication
(10) Pub. No.: US 2013/0125194 A1
(43) Pub. Date: May 16, 2013

(54) Converged Cable Access Platform for Provision of Video and Data Services

(71) Applicants: Jeff Finkelstein, Alpharetta, GA (US); Boris Brun, Brookline, MA (US); Adi Bonen, Belle Mead, NJ (US); Gil Katz, Sunnyvale, CA (US)

(72) Inventors: Jeff Finkelstein, Alpharetta, GA (US); Boris Brun, Brookline, MA (US); Adi Bonen, Belle Mead, NJ (US); Gil Katz, Sunnyvale, CA (US)

(73) Assignee: Harmonic Inc.

(21) Appl. No.: 13/297,211

(22) Filed: Nov. 15, 2011

(51) Int. Cl. H04N 21/61

(52) U.S. Cl. 725/129

(57) ABSTRACT

Systems, method, and computer program products for provisioning video and data services using a deep modulation Converged Cable Access Platform (CCAP) architecture in a traditional Hybrid Fiber Coaxial (HFC) network are described. The deep-modulation CCAP architecture includes a remote conversion unit (e.g., that includes one or more modulators and demodulators to perform signal modulation and demodulation) connected to a CCAP core through a digital optical medium (e.g., an optical fiber) to achieve higher network capacity as well as cost and power consumption reduction.

### TECHNICAL FIELD

The subject matter of this application is generally related to communication system and network design.

### BACKGROUND

High speed data service has become a ubiquitous part of modern life, and the availability of such service is of ever-increasing importance. Typically, numerous data service subscribers send and receive data through a service provider. The subscribers may be individual homes or businesses and the service provider may be a cable provider providing cable television (CATV) service to these subscribers. Subscriber data service is often provided over a physical medium that is also used to provide other types of service.

Cable television (CATV), originally introduced in the late 1940's as a way to transmit television signals by coaxial cables to houses in areas of poor reception, has over the years been modified and extended to enable the cable medium to transport a growing number of different types of digital data, including both digital television and broadband Internet data. One of the most significant improvements occurred in the 1990's, when a number of major electronics and cable operator companies, working through CableLabs®, introduced the Data Over Cable Service Interface Specification (DOCSIS). The DOCSIS standard defines the Physical Layers (PHY) and Media Access Control (MAC) layers needed to send relatively large amounts of digital data through coaxial cables that were originally designed to handle analog standard definition television channels. The unprecedented success of the broadband Internet Protocol (IP) data services and the promise of many more niche programming services forced the cable operators to upgrade their networks to accommodate the growth. A substantial number of fiber links using amplitude modulation and the distributed feedback lasers were deployed instead of long trunk coaxial cables. The new network was called Hybrid Fiber Coax network or HFC network.

However, HFC network has finite bandwidth available as well as limited frequency range for data transmission. Accordingly, there is a need for a new network architecture that accommodates more bandwidth to meet the ever-increasing demand for more capacity in audio and video applications.

### SUMMARY

Systems, method, and computer program products for provisioning video and data services using a deep modulation Converged Cable Access Platform (CCAP) architecture in a traditional Hybrid Fiber Coaxial (HFC) network are described. The deep-modulation CCAP architecture includes a remote conversion unit (e.g., that includes one or more modulators and demodulators to perform signal modulation and demodulation) connected to a CCAP core through a digital optical medium (e.g., an optical fiber), for higher network capacity, cost and power consumption reduction.

In some implementations, a system is provided that includes a core that includes: a packet processor; and an optical transceiver coupled to the packet processor and converts one or more data packets received from the packet processor into optical binary data streams; a conversion unit coupled to the core and converts the optical binary data streams from the core into binary electrical signals to be modulated by the conversion unit; and a coaxial medium coupled to the conversion unit to accommodate transmission of the modulated signals to one or more terminals.

In some implementations, a method is provided that includes receiving, at a conversion unit, a packet from a core, the packet being received from the core through an optical medium; converting, at the conversion unit, the packet from a first format to a second format; and transmitting the packet in the second format to one or more terminals through a coaxial medium.

In some implementations, a method is provided that includes receiving, at a conversion unit, a modulated packet from a terminal through a coaxial medium; converting, at the conversion unit, the modulated packet from a first format to a second format; and transmitting the converted packet to a core through an optical medium.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1(a) shows an example of a head-end of an HFC network.

FIG. 1(b) shows an example of an HFC network including the head-end shown in FIG. 1(a).

FIG. 1(c) shows a different view of the HFC network shown in FIG. 1(a).

FIG. 2 shows a hybrid TDM-WDM network return path.

FIG. 3 shows an example architecture of a deep-modulation CCAP.

FIG. 4 is an example of a flow chart for processing downstream data from a head-end.

FIG. 5 is an example of a flow chart for processing upstream data from one or more terminals.

FIG. 6 shows an example of a ranging diagram between a MAC, a remote conversion unit, and one or more terminals.

FIG. 7 is a block diagram of generic processing device that may be used to execute methods and processes disclosed herein.

Like reference symbols in the various drawings indicate like elements.

### DETAILED DESCRIPTION

Systems, method, and computer program products for provisioning video and data services using a deep modulation Converged Cable Access Platform (CCAP) architecture in a traditional Hybrid Fiber Coaxial (HFC) network are described. The deep-modulation CCAP architecture includes a remote conversion unit (e.g., that includes one or more modulators and demodulators to perform signal modulation and demodulation) connected to a CCAP core through a digital optical medium (e.g., an optical fiber) to achieve higher network capacity as well as cost and power consumption reduction.

In the deep-modulation CCAP architecture, video and data streams can be processed through the deep-modulation CCAP core. However, unlike the conventional CCAP architecture where the QAM (quadrature amplitude modulation) signals are modulated at a head-end, the deep-modulation CCAP architecture enables a physical separation of the physical layer (PHY) by allowing modulators and demodulators to be decoupled from the rest of the CCAP core and other functional blocks. For example, video and electrical binary streams can be converted to optical signals by digital optical transceivers at the head-end, and subsequently delivered to the remote conversion unit through the digital optical medium. The remote conversion unit then converts the optical data streams back to the original electrical binary data, performs data modulation on the original electrical binary data, and sends the modulated RF signal to the RF port. The RF port of the remote conversion unit is coupled to a coaxial network to allow the modulated data to be provided to the subscribers and home terminals through the coaxial network.

Unlike the conventional HFC networks where analog signals are used in both the optical and coaxial portions of the transmission path so that digital data could be represented by changes in the phase and/or amplitude of an analog radio frequency (RF) carrier wave, the deep-modulation CCAP architecture as described herein utilizes digital optical transmission that removes fiber analog optical modulation impairments, and provides additional bandwidth to the subscribers by increasing modulation order in the coaxial portion of the network.

Also, while the deep-modulation CCAP described herein refers to modulation/demodulation functionalities that are located deep in the network (e.g., near the edge between an optical medium and a coaxial medium) and closer to the subscriber terminals or devices, the location of these functionalities is application- and design-dependent, and other implementations also are contemplated.

### HFC Network Overview

CATV systems were initially developed to provide broadcast television content to subscriber premises over a wired connection. Early systems delivered analog television signals through a tree-and-branch coaxial cable architecture. These architectures also included numerous amplifiers, line extenders and other electronic components. CATV system operators subsequently began using HFC networks that replaced a portion of a coaxial cable signal path with a more efficient fiber optic communication path. Typically, an HFC network uses optical fibers to carry signals optically from a hub or other location to optical/electrical conversion nodes (“O/E nodes”). The O/E nodes then convert the optically transmitted signal to electrical signals that are transported from the O/E nodes to subscribers over coaxial cable.

Early HFC networks communicated only analog video signals. Now, television has migrated to digital video format. Providers, such as multiple service operators (MSOs), also employ HFC access networks to deliver high-speed data, telephony, video-on-demand (VOD) and numerous other services that rely on digital data. In effect, however, digital data is still carried over many HFC networks using analog signals. Specifically, digital data is often communicated in both the fiber and coaxial portions of an HFC network by modulating the phase and/or amplitude of a sinusoidal waveform. For example, a termination system, such as a cable modem termination system (CMTS), or other network element, may modulate digital data using quadrature amplitude modulation (QAM) or other modulation protocol. This results in an analog signal in which digital data is represented by changes in the phase and/or amplitude of an analog RF carrier wave. This analog signal is transmitted over the fiber portion of an HFC network by using a laser to generate that analog signal in optical form. An O/E node converts that optical analog signal to an electrical version of that signal to be forwarded over the coaxial portion of the network. Ultimately, the electrical version of the modulated analog signal is received at a device in a subscriber premises and demodulated to recover digital data. Analog optical transmitters, however, generate a significant amount of noise in HFC networks, which reduce the signal-to-noise ratio (SNR) of delivered signals.

As will be described below, in lieu of analog optical components, digital optical components can be used to deliver higher modulation signals over HFC network, accommodate greater bandwidth, achieve less power consumption, and reduce the overall system development cost. Specifically, digital data is communicated over the fiber leg of the HFC network that utilizes fiber optic lines. For example, digital data is communicated using binary modulation, with that digital data then recovered at an O/E node and used to modulate an analog waveform. As used herein, “binary modulation” refers to techniques that communicate digital data (e.g., “0” and “1” bits) using binary optical pulses. “Binary optical pulses” refers to pulses that can only have one of two values (e.g., either OFF or ON). As one simple example of binary modulation, a laser could be turned ON for a time period t1 to convey a “1” and turned OFF for the succeeding time period t2 to convey a “0”. However, binary modulation also includes more complex techniques such as using one sequence of binary optical pulses to convey a “1” and a different sequence of binary optical pulses to convey a “0”, using binary optical pulses of equal amplitude but of different duration to convey “0” and “1”. Conversely, “analog modulation” refers to techniques that communicate digital data by varying the amplitude, phase and/or other characteristic of an analog waveform. Examples of analog modulation include but are not limited to various types of QAM, phase shift keying (PSK), quadrature phase shift keying (QPSK), and Orthogonal Frequency Division Multiplexing (OFDM).

The below description also refers to medium access control (MAC) protocols. As used herein, “MAC” protocol refers to a scheme by which the use of a particular communication medium (e.g., an optical fiber or a coaxial cable) is controlled and managed. Some aspects of a MAC protocol may include rules regarding the contents of MAC headers, encapsulation and/or other formatting that must be added to protocol data unit (PDU) packets being transmitted on the medium. Other aspects of a MAC protocol can include rules by which a device contends for transmission opportunities and/or obtains permission to transmit on the medium. For example, a device at a subscriber premises, such as a cable modem, can be required to obtain permission from a MAC function located in an access platform, such as a converged multi-service access platform (CMAP), before sending a data block on a coaxial medium, may receive confirmation from a MAC function that a contention-based transmission was successful. Still other aspects of a MAC protocol can include other procedures for managing how various devices use a medium. As but one example, one device performing MAC functions can periodically determine physical distances to other devices and send management messages with timing adjustments, periodically send management messages instructing other devices to adjust transmission power, and periodically poll devices to determine if those devices are still online.

Different parts of an HFC network can use different MAC protocols. For example, a fiber leg of an HFC network can employ a MAC protocol associated with Gigabit Ethernet, with Ethernet passive optical network (EPON) standards (described, e.g., by Institute of Electrical and Electronics Engineers standard 802.3 and/or other IEEE standards), with Gigabit passive optical network (GPON) standards (as described, e.g., by International Telecommunication Union standard ITU-T G.984 and/or other ITU standards) or with some other set of standards. A coaxial leg of an HFC network can use a MAC protocol associated with the data over cable system interface specifications (DOCSIS) standards or with some other set of standards. More than one MAC protocol could be used on the same medium. For example, one MAC protocol could be used for communications over a fiber in one optical wavelength and a different MAC protocol could be used for communications over that fiber in a different optical wavelength. Similarly, one MAC protocol could be used for communications over a coax cable in one frequency band and a different MAC protocol could be used for communications over that cable in a different frequency band.

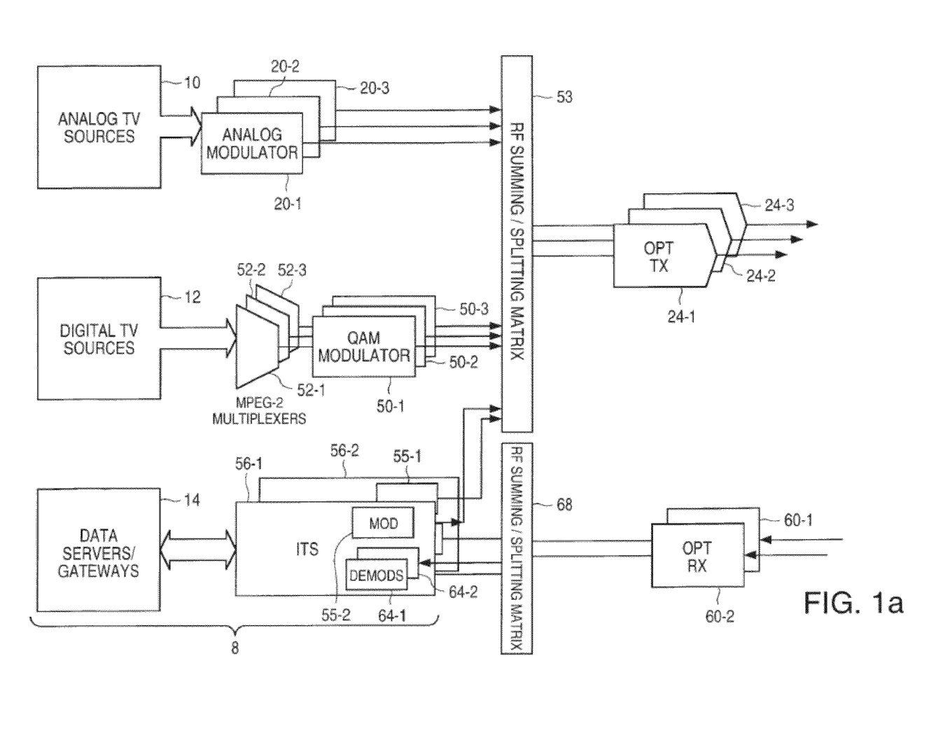

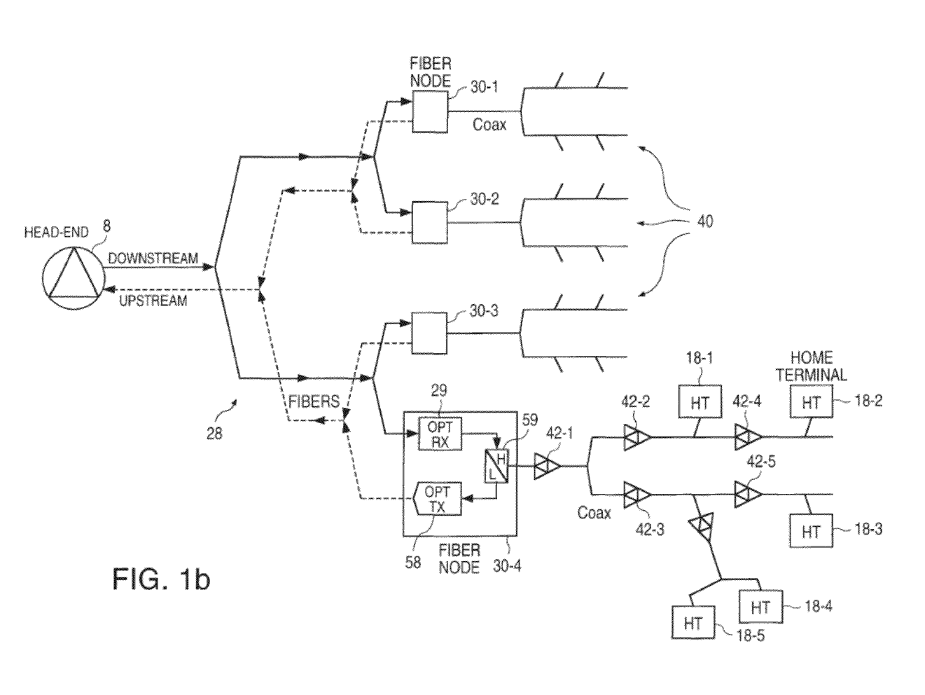

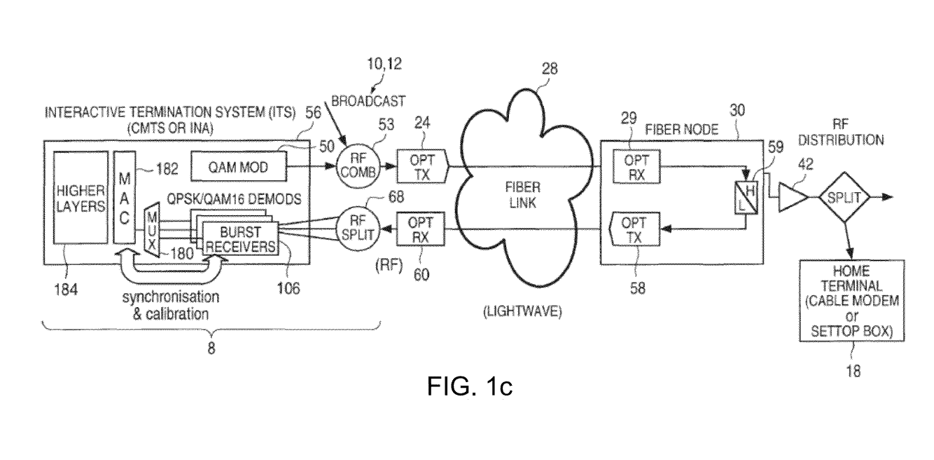

FIG. 1(a) shows an example of a head-end 8 of an HFC network, and FIG. 1(b) shows an example of an HFC network including the head-end 8. Referring to FIG. 1(a), the head-end 8 includes analog TV sources 10, digital TV sources 12, and data servers/gateways 14. These inputs 10, 12, and 14 receive input signals such as, without limitation, analog and digital television signals and the digital data signals from multiple local and remote sources (satellites, off-air sources, terrestrial microwave, local tape systems, local video servers, computer servers, IP routers), and condition these input signals for transmission to home terminals (HTs) 18-1, 18-2, 18-3, 18-4, and 18-5. The HTs 18-1 to 18-5 include analog and digital video set top boxes (e.g., cable TV set top boxes) and digital cable modems. The head-end 8 also receives the reverse (upstream) transmissions from the HTs 18-1 to 18-5, and processes the upstream transmission in coordination with the downstream transmissions and the input/output signals from/to external digital networks. The head-end 8 also includes an Interactive Termination System (ITS) 56-1 and 56-2 to perform the foregoing transceiving function with respect to the home devices and the core data networks connected to the head-end 8. The Head-End ITS refers to both CMTS and INA (interactive Network Adapters) Head-End (HE) controllers which implement the MAC layer as well as the higher level application layers and the PHY at the head-end 8.

As shown in FIG. 1(a), a downstream transmission includes transmitting analog video, digital video, and digital data. When transmitting analog video (e.g., from analog TV sources 10), the analog video is transmitted downstream via frequency division multiplexing (FDM), where a composite spectrum containing multiple analog channels is generated by radio frequency combining the output of analog modulators 20-1, 20-2, and 20-3 (e.g., via the RF combining matrix 53), each of which is driven by a baseband or IF analog video channel. The composite FDM signal is then forwarded to one or more linear analog laser transmitters 24-1, 24-2, and 24-3 to be transmitted over a “tree” structure 28 of optical fiber (FIG. 1(b)) to one or more fiber nodes 30-1, 30-2, 30-3, and 30-4, where the optical-to-RF conversion is performed by optical receivers 29 of the fiber nodes 30-1 to 30-4.

From the fiber nodes 30-1 to 30-4, the downstream output signals are distributed to the HTs 18-1 to 18-5 via a “tree and branch” structure 40, which includes, for example, coaxial cables with amplifiers 42-1, 42-2, 42-3, 42-4, and 42-5 placed at various parts of the “branches” to compensate for signal loss, taps and coaxial drops to the subscriber units or HTs 18-1 to 18-5. Each coaxial cable terminates in an RF set-top converter, which in some implementations, can bandpass select a particular analog television channel out of the composite spectrum.

For digital TV sources 12, digital QAM (quadrature amplitude modulation) modulators 50-1, 50-2, and 50-3 are used to map multiple streams (e.g., each with several tens of Mbps) into 6 MHz channels. The modulators 50-1 to 50-3 are positioned at the transmit side of a digital link, which runs over an analog linear medium, such as a hybrid fiber coaxial medium. The digital input to each QAM modulator 50-1 to 50-3 at the head-end 8 includes an MPEG-2 multiplexed digital signal carrying multiple digital video MPEG-2 programs from multiplexers 52-1, 52-2, and 52-3.

The digital video inputs to the multiplexers 52-1 to 52-3 are generated by digital video encoders in the digital TV sources 12 each of which digitizes and compresses an analog video input signal. The digital video input signals also can originate from digital video servers or be received from remote sources via satellites.

Similarly, the data signals are provided from the ITS 56-1 and 56-2 via modulators 55-1 and 55-2. On the transmit side, the RF combining matrix 53 can combine the RF signals carrying analog TV signals, digital TV signals, and data signals.

The coaxial cable path is used for return (upstream) as well as for forward (downstream) transmission. The frequency range of five to forty-two MHz band (e.g., as used in the US) and the corresponding range in international cable systems (e.g., a lowband) are generally dedicated to the upstream transmission. The HTs 18-1 to 18-5 (e.g., cable moderns and interactive digital video set top boxes), in addition to receiving downstream digital transmissions by the QAM demodulators, also have the ability to map their digital return transmissions onto RF waveforms using upstream burst transmitter modulators. Modulation formats from QPSK to 64-QAM are typically used.

Unlike the downstream transmission, in the return path, the upstream transmission is generally not of a continuous bitstream (as is for downstream) but occurs in bursts of short packets of data randomly in time. The data bursts at the HTs 18-1 to 18-5 are encoded into short sequences of symbols by, for example, a QPSK or 64-QAM burst transmitter modulator (e.g., at a burst transmitter). After upstream propagation to the head-end 8, the bursts are converted by a QPSK or 64-QAM burst receiver demodulator (e.g., at a burst receiver) into the original data packets (e.g., at the front end of the ITS 56-1 and 56-2). Several burst receivers may be used with a corresponding number of upstream channels with each receiver receiving packets over a single upstream channel frequency. Each upstream channel frequency may be shared by many HTs 18-1 to 18-5 via TDMA (Time-Division Multiple Access) as allocated by the ITS 56-1 and 56-2 at the head-end 8.

As discussed above, in the return path, signals from the HTs 18-1 to 18-5 propagate back to the head-end 8 (e.g., through the tree and branch” structure 40). The amplifiers 42-1 to 42-5 providing bidirectional capabilities are positioned along the return path to support the return signal. When the return signal reaches the fiber nodes 30-1 to 30-4, the returned signal is diplexed by a diplexer 59 (e.g., directed on a separate upstream path based on the orthogonality of the upstream and downstream frequency bands), amplified and forwarded to a return optical transmitter 58, and transmitted back up to the head-end 8 (e.g., on a separate optical medium than the one used for downstream transmission).

At the head-end 8, the return signal is photodetected at a return-path-receiver 60-1 and 60-2 (e.g., converted back to electrical form), split at the RF splitting matrix 68, and fed to the return path demodulators 64-1 and 64-2 of the ITS 56-1 and 56-2 for signal demodulation.

To increase capacity of the HFC network, a combination of a digital switching network and a multiplicity of smaller scale broadcasting subsystems can be employed, where the subscriber population is partitioned into multiple sets, with each set of subscribers being allocated with one or more bi-directional digital data streams. This “narrowcasting” architecture includes a master switched system or network, with the switch ports driving smaller scale HFC broadcast and each port addressing a serving area (e.g., a narrowcasting domain that includes a few tens or hundreds of subscribers). This narrowcasting architecture allows domain-specific digital content (e.g., two-way interactive data and interactive digital video such as VOD (Video-On-Demand)) to be routed or switched to/from each domain vat the head-end 8 or multiple hubs.

As subscriber penetration increases, it is ever more important to develop a process to efficiently transmit the return path signals from large number of subscribers back to the head-end 8 while maintaining the small upstream narrowcast domains. This is done by segmenting the HFC system into a larger number of return path domains, associating a smaller number of subscribers with each return path transmitter at the node. This is beneficial with respect to the ingress noise accumulation but also increases the upstream bandwidth per subscriber.

Once the digital capacity of the fixed return path portion of the spectrum (e.g. 5 to 42 MHz in the US, with each 3.2 MHz carrying 5 Mbps in QPSK, 10 Mbps in QAM16, 12 Mbps in QAM32 and 15 Mbps in QAM64 modulation) is divided among fewer subscribers, not only does the bandwidth per subscriber increase, but also the lower noise may allow using more spectrally efficient modulation schemes such as QAM-64 rather than QAM32, QM16 or QPSK.

In an example of partitioning a 2000-home node into four return paths each covering 500 homes, four groups of return demodulators may be used in the fiber node with each group listening to the FDM channels allocated on each of the four RF coaxial cable legs. The digital outputs from these return demodulators are time-division multiplexed at the node into a single digital stream. A digital baseband link running over fiber optics should then be provided from the fiber node to the head-end 8.

However, the capacity of an HFC network is largely limited by the frequency ranges supported by active components and passive components that are used to pass, direct, and amplify signals throughout the cable plant. The bandwidth of an HFC network is also affected by the attenuation on the coaxial portion of the HFC network. As the frequency of the transmitted signal increases, so does the attenuation of that signal, which limits the maximum distance that the transmitted signal can be effectively transmitted.

Also, with a 32×8 cable modem that supports thirty-two downstream channels and eight upstream channels, there is a usable bandwidth of approximately 1.2 Gbps for downstream channels and 200 Mbps for upstream channels. While such a bandwidth might meet today's demand, this bandwidth is insufficient to meet future needs. This is because high definition channels have significantly driven the bandwidth demand for more capacity, as many need to be simulcast as both SD, HD, and potentially 3D and over an IP platform, which causes a need for three to five times the number of channels previously used for the same content.

### Multiple Access Arbitration in Digital HFC Networks

Most cable systems employ centralized management schemes where the head-end 8 functions as the “master” (e.g., as a single point of coordination) and the HTs 18-1 to 18-5 function as the “slaves” (e.g., where the head-end 8 acts as the master and decides when the HTs 18-1 to 18-5, the slaves, are allowed to send data).

One critical layer for interactive communications with the HTs 18-1 to 18-5 (e.g., cable moderns and set top boxes) is the head-end MAC (Medium Access Control) layer, which is used to arbitrate access of multiple users. The MAC layer is located between the physical layer and the higher application-oriented layers. There are multiple choices for the implementation of the MAC layer.

FIG. 1(c) shows a different view of the HFC network shown in FIG. 1(a). As shown in FIG. 1(c), a calibration and synchronization (C&S) function is provided between the MAC 182 and the burst receivers 106 (e.g., as indicated by a double headed arrow) indicating the exchange of information between the burst receivers 106 and the MAC in the head-end 8. In addition, the ITS 56 includes a multiplexer 180 coupled to the MAC 182 and higher layers 184.

The MAC domain includes a set of all users served by one or more downstream channels and one or more upstream channels, bound together by a two-way MAC protocol so that the HTs 18-1 to 18-5 associated with the one MAC domain can have their return transmissions managed by the same MAC layer that controls the downstream channels covering the same HTs 18-1 to 18-5.

The schedule and other MAC timing and management messages are sent over one of the downstream channels (known as the “provisioning channel” in the DVB standard). Typically the MAC domains are defined with a single downstream channel that also carries the provisioning function. The downstream narrowcast domain associated with the particular QAM modulator is the union of the upstream narrowcast domains associated with each of the bursts receivers. Each MAC domain must be associated with one modulator tuned to the downstream provisioning channel.

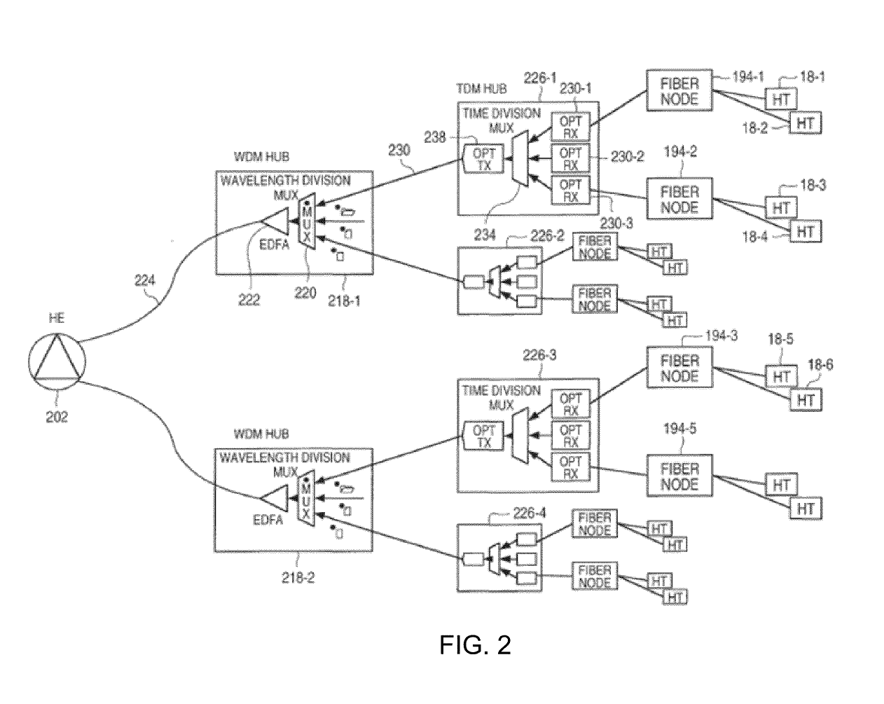

FIG. 2 shows a hybrid TDM-WDM network return path. Optical digital signals from several nodes are transmitted on different wavelengths, and concentrated onto a single fiber at a secondary hub 218-1 such as Wavelength Division Multiplexing (WDM) Hub 218-1 and 218-2 containing a WDM 220 and an erbium doped fiber amplifier 222, with the single fiber 224 being sent up to the head-end 202 to transport the aggregate of wavelengths, each carrying the digital transmission from one node.

In addition or in lieu of that, an intermediate TDM multiplexing layer may be implemented at a Time Division Multiplexing Hub (TDMH) 226-1, 226-2, 226-3, and 226-4 coupled at an intermediate location between the nodes 194 and the head-end 202 (or the WDMH 218). The TDMHs 226-1 to 226-4 concentrate the upstream digital traffic arriving over digital fibers from multiple nodes into a single digital stream aggregating the individual digital upstream transmissions from the nodes. The TDM (or statistical packet) multiplexed signal is then directed over an output optical fiber 230, this time in baseband to the head-end, either directly or possibly via an intermediate WDMH 218-1/218-2 in which case the output fiber 230 carries an optical signal at a particular wavelength, distinct from those of other TDMHs. Each TDMH 226 includes several optical receivers 230-1, 230-2, and 230-3, a TD multiplexer 234, and an optical transmitter 238.

### Deep-Modulation CCAP System Overview

As will be discussed in greater detail below, a deep-modulation CCAP is provided that accommodates the delivery of higher capacity QAM signals. The deep-modulation CCAP can utilize digital protocols for transmitting the MAC to PHY connection over an optical medium to allow the modulators and demodulators to be decoupled from the rest of the deep-modulation CCAP functional blocks. In so doing, the modulators and demodulators can be placed deeper into the network, allowing extension of the edge of fiber and coaxial plants to be as close to the subscriber devices as the operational and capital expenditures or design constraints will allow. Placing the modulators and demodulators closer to the subscriber allows a lesser number subscribers per optical fiber, which increases the bandwidth for each subscriber while reducing the overall noise present in the network. For example, the deep-modulation CCAP allows modulators (e.g., QAM modulators 50) and burst receivers (e.g., burst receivers 106) to be placed between optical receivers (e.g., optical receivers 29) and optical transmitters (e.g., optical transmitters 58) of a fiber node (e.g., fiber node 30) and diplexers (e.g., diplexer 59), which then allows the HFC network to eliminate the RF combining matrix 53 and the RF splitting matrix 68.

The deep-modulation CCAP can employ a digital platform with the remote modulators and demodulators connected to a CCAP core through an optical fiber to physically separate the MAC and associated PHY. For the downstream path, the video and data streams can pass through the CCAP core. These data streams are not modulated into QAM signals at the head-end by the CCAP core but are converted into optical data streams by digital optical transceivers, which can subsequently be delivered through the optical fiber to a remote conversion unit where the optical data stream is converted back to the original electrical binary data form prior to performing data modulation. The output of the remote conversion unit can be connected to a coaxial network and combined with broadcast legacy services for delivery to subscriber devices. In the return (upstream) path, a reverse process can be employed to demodulate the received signals from subscriber devices for transmission back to the CCAP core over the optical fiber using separate wavelengths.

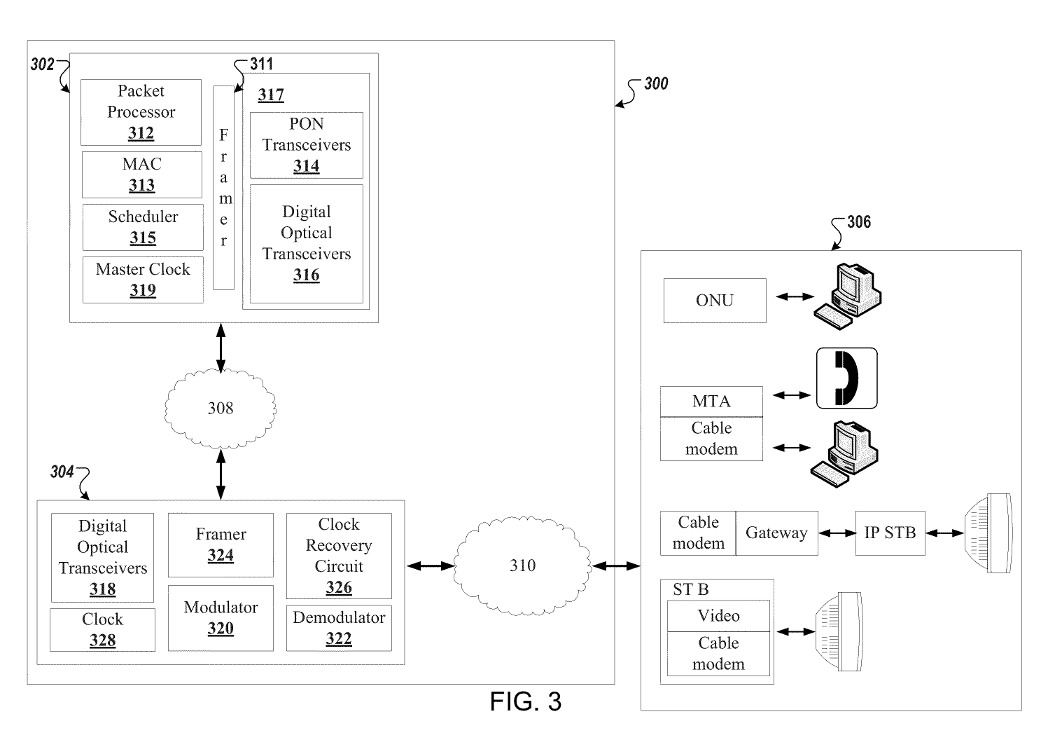

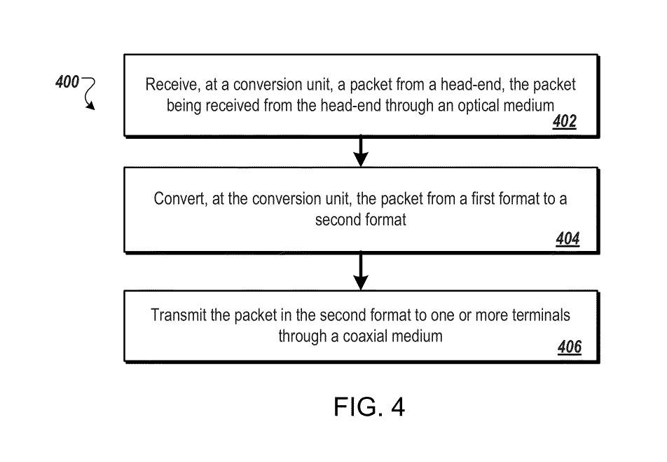

FIG. 3 shows an example architecture of a deep-modulation CCAP 300. FIG. 3 will now be described in conjunction with FIG. 4. FIG. 4 is an example of a flow chart 400 for processing downstream data from a CCAP core. The operations described in process 400 are not to be construed as necessarily requiring their performance in the particular order discussed or illustrated, unless specifically identified as an order of performance. It is also to be understood that additional or alternative operations may be employed.

At 402, a packet is received at a remote conversion unit from a CCAP core, the packet being received from the CCAP core through an optical medium. For example, as shown in FIG. 3, the deep-modulation CCAP 300 includes a conversion unit 304 that receives downstream data from a CCAP core 302 that is to be distributed to a plurality of terminals 306. The terminals 306 can include one or multiple subscriber devices. As used herein, a “subscriber” is a user such as a person, corporation or other entity that has arranged to obtain access to, and one or more services from, a network; the arrangement may (but need not necessarily) involve a fee or contractual relation. Each subscriber device can be, for example, a modem such as a cable modem (CM), a set top terminal (STT), a media terminal adaptor (MTA), a display device, or another device through which other devices (e.g., computers) in a subscriber premises can communicate over the deep-modulation CCAP 300.

The deep-modulation CCAP 300 employs coaxial and optical medium for transmitting the downstream data. For example, the CCAP core 302 can communicate with the remote conversion unit 304 over an optical medium 308, and the remote conversion unit 304 can communicate with the terminals 306 over a coaxial medium 310. In some implementations, the optical medium 308 can include an optical fiber or multiple optical fibers, amplifiers, splitters, or other optical devices for supporting the transmission of optical signals through the optical medium 308. Similarly, the coaxial medium 310 can include a coaxial network or cable split to the terminals 306. Though not shown, the coaxial medium 310 can include one or more separate sections of coaxial feeder and drop cables as well as amplifiers, splitters and other components to support the transmission of modulated RF signals to the terminals 306.

In some implementations, the optical medium 308 can be configured to generate a 10 Gbps throughput in order to accommodate 250 QAM channels. For example, the optical medium 308 can provide a 10 Gbps link that drives two coaxial links of 125 downstream channels, 4 coaxial links of 62 downstream channels, or a combination thereof.

The CCAP core 302 can communicate with the remote conversion unit 304 using one or more access interfaces 317 that include one or more passive optical network (PON) transceivers 314 or other digital optical transceivers 316. In general, the CCAP core 302 can perform functions of a cable modem termination system (CMTS) that sends and receives data services to individual subscribers, and functions of Edge QAM (EQAM) devices that provides video services to individual subscribers. Specifically, the CCAP core 302 and remote conversion unit 304 can provide the functionality of a CMTS and an EQAM in a single architecture with greater QAM density and overall capacity. A CMTS provides an operator network side termination for a DOCSIS link, and communicates cable modems to provide data services. An EQAM functions to receive packets of digital video or data from an operator network, re-packetize the video or data into an MPEG transport stream, and digitally modulate the MPEG transport stream onto a downstream RF carrier using QAM.

In some implementations, the digital optical transceivers 316 can utilize wavelength division multiplexing (e.g., coarse or dense) to combine multiple wavelengths for delivery that allows greater bandwidth availability. For example, using 10-Gbps technology, three wavelengths can be used to bring 30 Gbps to a four RF port conversion unit (or 7.5 Gbps per downstream coaxial link). Wavelength division multiplexing also can be used by a point-to-multipoint network, where the fiber can be split between multiple conversion units. For example, in the downstream direction, a single wavelength can be shared between multiple coaxial links, whereas in the opposite direction, each upstream link requires a separate wavelength.

The PON transceivers 314 also can be used to transmit the optical signals over a PON network. For example, the PON network can provide a link that can be symmetrical or asymmetrical (e.g., with upstream speeds up to 1 Gbps for Gigabit Ethernet PON (or GEPON), 2.5 Gbps for 10-Gigabit-Per-Second PON (or XGPON), or 10 Gbps at line rate for GEPON and XGPON). The PON network can introduce approximately 2 ms of delay to the upstream link and increase the round-trip time of the DOCSIS system. Round-trip time impacts the performance of a single modem by limiting the number of grants the modem can receive in a given time. However, the PON network can be a cost effective solution for small one-port PHY devices.

In addition to the access interfaces 317, the CCAP core 302 also can include a packet processor 312. In some implementations, the packet processor 312 can initially buffer incoming packets from a backbone network in a queue. The backbone network can include a system operator's national IP network, the Internet, or a combination thereof. Data corresponding to services can be received from and sent to the backbone network (e.g., by routers). Such data can include broadcast data (e.g., television and cable network programming), narrowcast data (e.g., VOD and switched digital video (SDV) programming) and unicast data (e.g., high speed data (HSD) service providing Internet connectivity to individual subscribers and VoIP or other type of telephone service, emails, Internet web pages, and other electronic data).

Where packets are buffered in a queue, the packet processor 312 can remove the incoming packets from queue 24 and determine what type of data is contained in the packets. For example, the packet processor 312 can filter predefined fields of the packets to identify the data contained in the packets. In some implementations, these predefined fields can be inserted into the packets in advance by the network backbone. One or more of such fields also can have values identifying packets as subscriber data, SPTS data, or control messages. Additional predefined fields further can identify the destination of the data in the packets. The destination can be a single terminal (e.g., a single subscriber device) or multiple terminals (e.g., multiple subscriber devices). Other predefined fields can identify various QoS parameters for the data in the packets whose parameters can be used to classify that data according to one or more service flows. A service flow can be a DOCSIS service flow or one established for VOD or other type of multicast, narrowcast and/or unicast service. In general, the packet processor can perform packet classification, rate shaping, packet queuing, QoS, routing, and flow control. Also, the network backbone can insert various values identifying the packet data type, the values identifying destinations, and values identifying QoS values into the packets prior to being processed by the packet processor 312.

In some implementations, the output of the packet processor 312 (or CCAP core 302) includes packets formatted according to DOCSIS protocol, and can be stored in a buffer.

Although not shown, the packet processor 312 can include internal memory or external memory that can be accessed via one or more data busses in the backbone network. The memory can include volatile and non-volatile memory and can include any of various types of storage technology, including one or more of the following types of storage devices: read only memory (ROM) modules, random access memory (RAM) modules, flash memory, and EEPROM memory. The packet processor 312 also can be implemented with any of numerous types of devices, including but not limited to one or more general purpose microprocessors, one or more application specific integrated circuits, one or more field programmable gate arrays, and combinations thereof. In some implementations, the packet processor 312 can carry out operations described herein according to machine readable instructions stored in the memory and/or stored as hardwired logic gates within the packet processor 312.

In some implementations, data can first be prepared delivery over the optical medium 308 using IEEE 802 protocols (e.g., IEEE 802.3x) or PON protocols. For example, different headers can be attached to the data/video traffic prior to transmission.

In some implementations, the CCAP core 302 can include a MAC 313 and a scheduler 315. The MAC 313 can be a DOCSIS MAC and/or a MPEG MAC. The MAC 313 can be connected to the scheduler 315 and a framer 311 for processing the data packets from the packet processor 312. Generally, the MAC 313 can function as a network manager and establish the connection between the CCAP core 302 to the terminals 306, and handle downstream bandwidth management and terminals management. In some implementations, the scheduler 315 can be used to manage the upstream bandwidth sharing between various terminals 306.

The MAC 313 can perform DOCSIS Media Access Control (MAC) functions, which include, without limitation, signaling, downstream bandwidth scheduling, and DOCSIS framing. The MAC 313, in some implementations, can be configured to perform packet processing functions. For example, the MAC 313 can be enabled to process a plurality of channels of data, each channel having a given levels of priority. The MAC 313 also can be enabled to time division multiplex the processor bandwidth across each of the channels and the associated priority level. A continuous stream of data can be provided to the MAC 313, for example, from a DOCSIS cache storing the buffered data.

In preparing the packets for transmission, the MAC 313 also can perform various DOCSIS operations such as, without limitations, tag information identification, payload header suppression, baseline privacy, and DOCSIS header creation. For example, the MAC 313 can identify the tag information on incoming packets that indicates what processing operations are to be performed. As another example, the MAC 313 can perform payload header suppression operation that causes fixed fields in the packet header to be replaced with smaller tags. As yet another example, the MAC 313 can execute baseline privacy operation that causes a large portion of the packet to be encrypted with either Data Encryption Standard (DES) or Advanced Encryption Standard (AES). As yet another example, the MAC 313 can perform DOCSIS header creation operation that causes the creation and insertion of DOCSIS Extended Headers and creation of DOCSIS header elements. The DOCSIS header creation function also can create a header Cyclic Redundancy Check (CRC) for checking and correcting errors.

The MAC 313 also can format and manage Moving Picture Experts Group Transport Stream (MPT) packets or Packet Streaming Protocol (PSP) packets. Packets in a channel, based on channel provisioning, can either be assigned for MPT mode or PSP mode processing. A channel can be provisioned for either MPT or PSP processing and all data on that channel can be routed to the framer 311 for transmission to the remote conversion unit 304 through the digital optical transceivers 316 or through the PON transceivers 314. The PON transceivers 314 can be used to route the packets to a PON, or a point-to-multipoint optical network (e.g., in lieu of the optical medium 308). The digital optical transceivers can transmit; for example, 10 Gb of data per second over a point-to-point optical network for the distance of up to 80 km in both the upstream and downstream directions.

The PSP format provides encapsulation of DOCSIS formatted packets in the L2TPV3 protocol. PSP is a layer 4/5 protocol that allows concatenation of multiple small packets into a larger packet and fragmentation of a large packet, exceeding the programmed Maximum Transmission Unit (MTU) size, into smaller packets. PSP packets can be transmitted to and processed by a modulator 320. The MPEG-2 Transmission Convergence layer protocol encapsulates the PSP formatted packets into MPEG2 frames. This allows MPEG2 encapsulated PSP data to be multiplexed with other MPEG streams on the same carrier on the forward path. For example, MPEG2 video and audio may be sent on the same carrier as MPEG2 encapsulated PSP data.

As described above, packets formatted according to DOCSIS protocol by the MAC 313 can be formatted according to MPT format (e.g., instead of PSP format) prior to being sent from the CCAP core 302 to the modulator 320 at the remote conversion unit 304. Packet header information can be used to determine whether to process according to PSP or MPT format. The MPT format is a collection of MPEG2 packets into a single frame that is encapsulated in an L2TPV3 header. The MAC 313 format the DOCSIS packets according to the MPEG2 Transmission Convergence Layer protocol. Since MPEG2 packets are fixed in size, the number of MPEG2 packets that can be placed in a L2TPV3 frame is chosen to not exceed the Maximum Transmission Unit (MTU) size. Since the size of each MPEG2 packet and the number of MPEG2 packets in an L2TPV3 frame is fixed, there is no overhead of fragmentation and concatenation of frames in MPT mode processing.

When video or data packets are ready for delivery, the digital optical transceivers 316 (or the PON transceivers 314) can convert the packets into optical format for transmission to the remote conversion unit 304 via the optical medium 308.

By utilizing digital optical components in the CCAP core 302, RF or analog components or functional blocks can be eliminated, which significantly increase the available space and the port density of the CCAP core 302. Further, by using digital optical components instead of analog components, significant saving in power consumption can be realized.

Referring back to FIG. 4, at 404, the packet is converted from a first format to a second format at the remote conversion unit 304. For example, the remote conversion unit 304 receives downstream data from the CCAP core 302 through the optical medium 308 and forwards the downstream data to the terminals 306 through the coaxial medium 310. Similarly, the remote conversion unit 304 receives upstream communications from the terminals 306 through the coaxial medium 310 and forwards those upstream communications to the CCAP core 302 through the optical medium 308. The upstream and downstream data communicated over the optical medium 308 can be in the binary format, while communications communicated over the coaxial medium 310 can be in the RF format. Upon receiving an optical downstream signal from the CCAP core 302, the remote conversion unit 304 can recover the binary digital data from the optical downstream signal. The remote conversion unit 304 can then modulate and up-convert the electrical signal (or signal component) to generate a modulated RF signal. The modulated RF signal (or component) can then be transmitted through the coaxial medium 310 for delivery to the terminals 306. Similarly, when the remote conversion unit 304 receives upstream packets (e.g., in RF format) from the terminals 306, the remote conversion unit 304 can demodulate the upstream packets to recover upstream data and convert the recovered data into digital optical data streams to be transmitted to the CCAP core 302.

In some implementations, the remote conversion unit 302 can include a modulator 320 to perform modulation and up-conversion for the downstream channels. The modulator 320 also can perform forward error correction on the RF signals. Similarly, the demodulator 322 can perform demodulation functions such as down-converting the upstream channels as well as error correction. In some implementations, both the modulator 320 and the demodulator 322 can function as the coaxial PHY between the terminals 306 and the remote conversion unit 304, whereas the digital optical transceivers 318 can function as the optical PHY between the remote conversion unit 304 and the CCAP core 302.

The modulator 320 can function to modulate broadcast and narrowcast data. Unlike conventional QAM modulators/demodulators that are typically located at the head-end to perform modulation/demodulation, the modulator 320 can be physically separated from the CCAP core 302. The optical signals received from the CCAP core 302 can be processed by the remote conversion unit 304 to recover the original electrical downstream data, after which the modulator 320 can modulate the recovered data, which can include broadcast, narrowcast and unicast downstream data, into RF frequency channels.

At 406, the packets can be transmitted in the second format to one or more terminals through a coaxial medium. For example, the packets can be transmitted in the RF format through the coaxial medium 310. In some implementations, the RF frequency channels can be combined or multiplexed and transmitted for distribution over the coaxial medium 310 to individual terminals 306 such as, for example, cable modems (CMs), set top boxes (STBs), media terminal adapters (MTAs), or other cable network devices. Similarly, upstream transmissions from individual terminals 306 can be received at the remote conversion unit 306 via one or more demodulators 322, demodulated and converted into optical signals by one or more digital optical transceivers 318, and forwarded to the CCAP core 302, where the optical signals can be converted back to electrical signals and further processed.

For example, in the upstream path, the demodulator 322 can receive and demodulate the DOCSIS messages from the terminals 306 and send the demodulated DOCSIS messages and data to the CCAP core 302.

In general, the framer 311 can insert synchronization messages and remote conversion unit's management messages into the standard downstream data and video traffic, while the framer 324 can insert timing and control information into the upstream traffic. New headers can be added to the packets above the DOCSIS or MPEG packets and a special protocol for communication over fiber can be introduced. As an example of such protocol can be L2TPV3. The framer 311 can receive the upstream data stream from the digital optical transceiver 316, while the framer 324 can receive the downstream data from the digital optical transceiver 318 and decapsulate the received data from the layers above DOCSIS and MPEG, such that the modulator 320 receives “pure” DOCSIS and MPEG packets in the downstream direction while the packet processor 312, the MAC 313 and the scheduler 318 receive “pure” DOCSIS packets in the upstream direction.

Also, the framer 311/324 can prepare the data for the robust high speed communication over fiber by adding special coding ability. For example, it can be a 8b/10b code and/or 64b/66b code.

As discussed above, the terminals 306 can include any wired or wireless device such as, without limitations, any type of computer server, laptop, Personal Computer (PC), and other similar electronic devices that communicate over the coaxial medium 310 through cable modems. The cable modems can be located in a customer premise equipment, in a separate chassis, or integrated into a set top box. The cable modem can operate a DOCSIS MAC that conducts DOCSIS messaging and transfer DOCSIS frames with the MAC 313 in CCAP core 302.

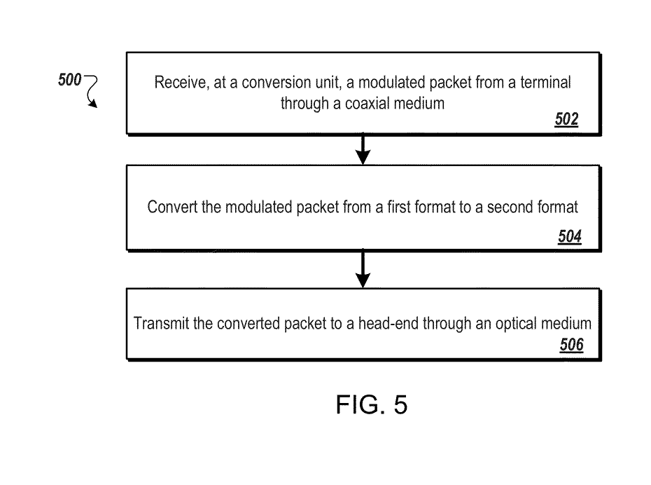

FIG. 5 is an example of a flow chart 500 for processing upstream data from one or more terminals. At 502, a conversion unit receives a modulated packet from a terminal through a coaxial medium. For example, the remote conversion unit 304 receives a modulated packet from the terminals 306 through the coaxial medium 310. At 504, the modulated packet is converted from a first format to a second format. For example, the digital optical transceivers 318 can convert packets in RF format into digital (or binary) optical format. At 506, the converted packet is transmitted to a CCAP core through an optical medium. For example, the converted packet is transmitted to the CCAP core 302 through the optical medium 308. Upon receiving the packets at the CCAP core 302, the CCAP core 302 can convert the received packets to the binary electrical format, decouple the DOCSIS packets, and send the DOCSIS packets to the MAC 313, scheduler 315, and the packet processor 312 for further packet processing.

### Time Synchronization

As discussed previously, the remote conversion unit 304 can include an internal modulator 320 and an internal demodulator 322 to perform modulation and demodulation related functions. In some implementations, the CCAP core 302 can include a master clock 319, and a local clock 328 of the remote conversion unit 304 can be synchronized with the master clock 319 (e.g., the local clock 328 is synchronized with the master clock 319). In some implementations, the master clock 319 can be a 10.24 MHz clock. In some implementations, a clock recovery circuit 326 can be provided in the remote conversion unit 304 to derive the original clock from the data stream from the CCAP core 302. In some implementations, the clock recovery circuit 326 can be implemented in a digital optical transceiver (e.g., digital optical transceivers 316/318). The clock recovery circuit 326 can include a phase locked loop (PLL) to perform the clock recovery 326 that locks to the input data stream. For example, the clock recovery circuit 326 can include a phase detector, a loop filter coupled to the output of the phase detector, a voltage-controlled oscillator (VCO) coupled to the output of the loop filter, and a D flip flop to receive the clock signal from the VCO at the clock input and the input data stream at the data input.

For example, a master clock of 10.24 MHz can be used with a K/L ratio to generate a 156.25 MHz clock, which is then used by the digital optical transmitter 316 to generate a 10312.5 MHz line clock. The digital optical transmitter 316 can send the data that is synchronized to this line clock. At the remote conversion unit 304, the clock recovery circuit 326 can derive the 10312.5 MHz line clock from the data, and divide this clock back to 156.25 MHz. The L/K ratio is then implemented to convert the 156.25 MHz clock to 10.24 MHz. In so doing, the remote conversion module 304 can recover the same 10.24 MHz local clock as the master clock 319.

While the foregoing description employs a 10312.5 MHz as the data line rate, other data rates also can be chosen. For example, where the communication link between the CCAP core 302 and the remote conversion unit 304 supports 8 Gbps and up to 11.3 Gbps, a data rate of 10,240 Mbps, 11,264 Mbps, or any other data rate that fits the overall architecture and design requirements can be chosen as the data line rate between the CCAP core 302 and the remote conversion unit 304.

In some implementations, the master clock 319 at the CCAP core 302 can include a sync message in the outgoing packets containing a timestamp. The remote conversion unit 304 can de-encapsulate the sync messages, extract the timestamp, and setup the local counter to the value shown in the timestamp. In so doing, the same time domain can be established between the CCAP core 302 and the remote conversion unit 304.

### MAC-PHY Ranging

A ranging process is used to compensate for the delays that exist between the CCAP core 302 and the remote conversion unit 304 (e.g., between MAC and PHY). Since conventional cable modem ranging is done with respect to measurements taken at the upstream PHY, the amount of correction that will be required is generally the difference between the downstream offset from the MAC to the downstream PHY and the difference between the upstream offset from the MAC to the upstream PHY. This MAC to PHY ranging is typically performed prior to or at the same as the conventional cable modem ranging, which is done on the layer above DOCSIS. The conventional cable modem ranging process is used to compensate for the delays that exist between the modulator 320 and the demodulator 322 to the terminals 306 (e.g., between PHY and cable modems).

In some implementations, the demodulator 322, which can function as an upstream receiver, can be used to measure various ranging performance-related parameters such as power, frequency, timing and equalization adjustments for each logical channel and deliver the results to the MAC 313 at the CCAP core 302.

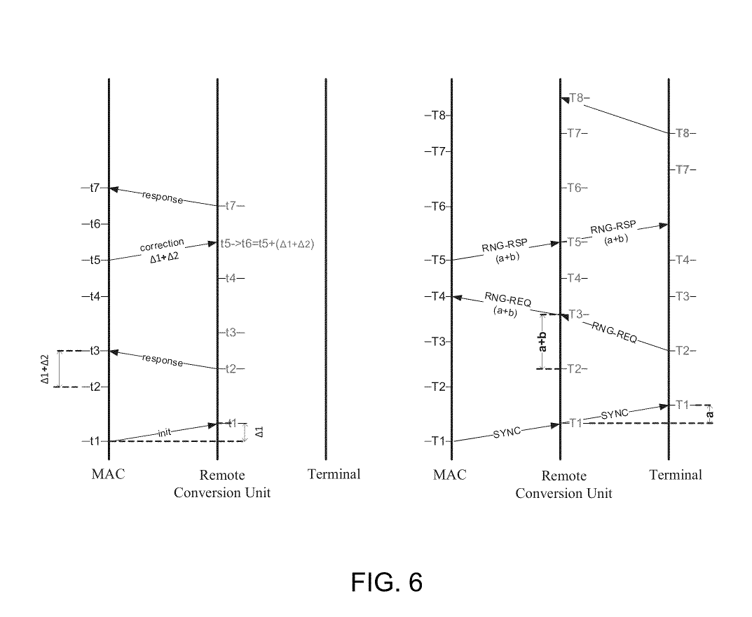

FIG. 6 shows an example of a ranging diagram between the MAC 313, the remote conversion unit 304, and the terminals 306. In performing the ranging process between the MAC 313 and the remote conversion unit 304 (hereinafter “MAC-PHY” ranging process), at time t1 (where “t1” represents a value of a master timestamp indicated by the master clock 319), the MAC 313 can send an initialization (init) message to the remote conversion unit 304. The “init” message can include a “t1” timestamp from the master clock 319 (which also can include a master counter) located at the CCAP core 302. Upon receiving the “init” message, the remote conversion unit 304 can extract the “t1” timestamp and set the local timestamp counter fed by the local clock 328 to match the “t1” timestamp. The “init” message can also include the request to send the “response” message at time “t2”. The remote conversion unit 304 can send the “response” message at time “t2,” but the MAC313 will actually receive it at time “t3.” In this way, the MAC 313 can determine that the delay between the MAC 313 and the remote conversion unit 304 is t3−t2 or Δ1+Δ2, where Δ1 is a delay associated with the downstream fiber link and Δ2 is a delay associated with the upstream fiber link. In the next correction message, the MAC 313 can correct the local clock 328 and associated local counter at the remote conversion unit 304.

As discussed previously, the framer 311 can insert new packets of initialization and correction to the data and video downstream traffic. Similarly, the framer 324 can insert the packets of the remote conversion unit 304 response to the data and video upstream traffic.

After completing the MAC-PHY ranging process, the MAC 313 can take into account the delay associated with the optical medium 308 for the accurate MAP message allocation. The ranging process between the remote conversion unit 304 and the terminals 306 also can be performed at the same time as or subsequent to the MAC-PHY ranging process. At time “T1,” (where “T1” represents a value of a master timestamp indicated by the master clock 319), the MAC 313 sends a DOCSIS SYNC message to the remote conversion unit 304. The SYNC message can include a “T1” timestamp from the master clock 319. Upon receiving the SYNC message, the remote conversion unit 304 extracts the “T1” timestamp and sets the local DOCSIS timestamp counter fed by local clock 328 to match the “T1” timestamp. In so doing, the local DOCSIS timestamp counter of the remote conversion unit 304 can be synchronized to the master DOCSIS timestamp counter fed by master clock 319, which can subsequently be used as a reference point for future timing adjustment procedure between modulator 320/demodulator 322 and terminals 306.

When a terminal such as a cable modem receives the SYNC message, the cable terminal initializes its own timestamp counter to match the “T1” timestamp. The error between timestamp in the remote conversion unit 304 and the timestamp of the cable modem is represented by “a.” The error “a,” in effect, indicates the time delay of the downstream link (e.g., the coaxial medium 310).

As discussed previously, the MAC 313 can generate DOCSIS frames for DOCSIS messages such as MAP (Bandwidth Allocation Map) messages. MAP messages notify a cable modem when the cable modem can transmit its data as well as when there are available contention time slots to transmit bandwidth request frame messages. A map message can be formatted into a DOCSIS frame or MPEG packet, and sent to the cable modem that allocates the timeslot transmission opportunities to the cable modem in response to a request message. For example, from a MAP message, the cable modem obtains the permission to transmit a RNG-REQ (Ranging Request) message at time “T2” to the MAC 313. The upstream receiver (e.g., demodulator 322 then waits for the RNG-REQ message from the cable modem at time “T2,” and receives the RNG-REQ message at time “T3.” At this moment, the remote conversion unit 304 identifies the timing error of the cable modem as “a+b” where “b” is the delay of the upstream link (e.g., the coaxial medium 310), and transmits the timing error to the MAC 313. The MAC 313 receives the timing error at “T4” and sends a RNG-RSP (Ranging Response) message with the timing correction information to the cable modem at “T5.” After the cable modem receives the timing correction information, the cable modem adjusts its counter to achieve synchronization with the master clock 328. Unlike the conventional ranging calibration, which is performed between the core and the terminals, the ranging process as described in FIG. 6 allows the participation of the CCAP core 302, the remote conversion unit 304, and the terminals 306 to provide a more accurate ranging system.

### Example Computer System

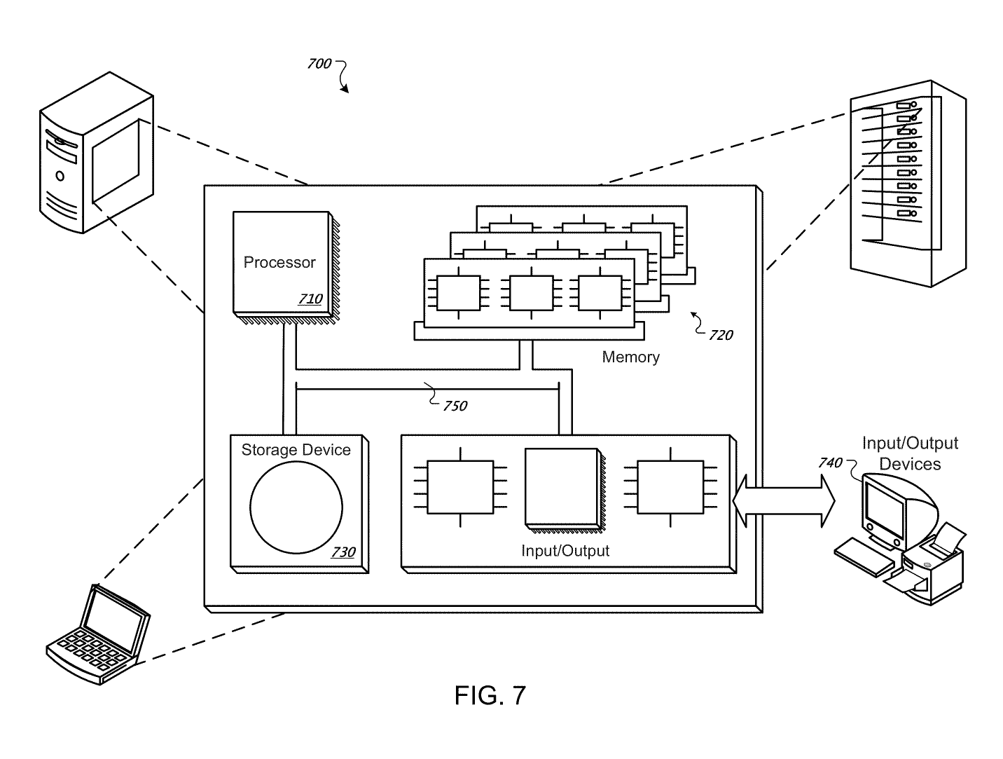

FIG. 7 is a block diagram of generic processing device that may be used to execute methods and processes disclosed herein. The system 700 may be used for the operations described in association with the method 700 according to one implementation. The system 700 may also be used for the operations described in association with process 200 according to another implementation.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 720 is a volatile memory unit. In other implementations, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device.

In another implementation, the input/output device 740 includes a display unit for displaying graphical user interfaces.

A few implementations have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof, including potentially a program operable to cause one or more data processing apparatus to perform the operations described (such as a program encoded in a computer-readable medium, which can be a memory device, a storage device, a machine-readable storage substrate, or other physical, machine-readable medium, or a combination of one or more of them).

The features described may be implemented in digital electronic circuitry, or in computer hardware, firmware, software, or in combinations of them. In some implementations, the apparatus may be implemented in a computer program product tangibly (e.g., non-transitory) embodied in an information carrier, e.g., in a machine-readable storage device, for execution by a programmable processor; and method steps may be performed by a programmable processor executing a program of instructions to perform functions of the described implementations by operating on input data and generating output. In other implementations, the apparatus may be implemented in a computer program product tangibly embodied in an information carrier for execution by a programmable processor. In some implementations, the information carrier can include a propagated signal.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The term “system” encompasses all apparatus, devices, and machines for processing data, including by way of example a programmable processor, a computer, or multiple processors or computers. The system can include, in addition to hardware, code that creates an execution environment for the computer program in question, e.g., code that constitutes processor firmware, a protocol stack, a database management system, an operating system, or a combination of one or more of them.

A program (also known as a computer program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A program can be deployed to be executed on one computer or on multiple computers that are located at one site or distributed across multiple sites and interconnected by a communication network.

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

A number of embodiments of the invention have been described. Nevertheless, it will be understood that various modifications may be made without departing from the spirit and scope of the invention. Accordingly, other embodiments are within the scope of the following claims.

What is claimed is:

1. A system comprising:
a core that includes:
a packet processor; and
an optical transceiver coupled to the packet processor and converts one or more data packets received from the packet processor into optical binary data streams;
a conversion unit coupled to the core and converts the optical binary data streams from the core into binary electrical signals to be modulated by the conversion unit; and
a coaxial medium coupled to the conversion unit to accommodate transmission of the modulated signals to one or more terminals.

2. The system of claim 1, wherein the optical transceiver is coupled to the conversion unit through an optical medium.

3. The system of claim 1, wherein the packet processor includes a framer that inserts one or more synchronization messages into the one or more data packets to be converted into the optical binary data streams by the optical transceiver.

4. The system of claim 1, wherein:
the core includes a master clock specifying master timing information; and
the conversion unit includes a clock recovery circuit and a local clock, the clock recovery circuit configured to recover the master timing information based on the optical binary data streams received from the core such that the local clock is synchronized to the master clock based on the recovered master timing information for establishing a same time domain between the core and the conversion unit.

5. The system of claim 4, wherein:
the conversion unit includes an optical transceiver to convert the optical binary data streams from the core into the binary electrical signals; and
the clock recovery circuit resides in the optical transceiver of the conversion unit.

6. The system of claim 4, wherein the clock recovery circuit includes a phase locked loop to perform clock recovery, the phase locked loop including:
a phase detector;
a loop filter coupled to an output of the phase detector;
a voltage-controlled oscillator (VCO) coupled to an output of the loop filter; and
a flip flop to receive, from the VCO, a clock signal at a clock input and an input data stream at the data input.

7. The system of claim 4, wherein:
the core further includes a media access control module that sends an initial message including a first timestamp from the master clock to the conversion unit;
the conversion unit receives the initial message and sets the local clock to match the first timestamp.

8. The system of claim 7, wherein:
the media access control module sends the initial message at a first clock;
the conversion unit, at a second clock, sends a response message to the media access control module that is to be received at a third clock such that the media access control module determines a delay between the core and the conversion unit based on a difference between the second clock and the third clock and adjusts the local clock based on the delay.

9. The system of claim 1, wherein the conversion unit includes a demodulator for demodulating one or more signals output from the coaxial medium.

10. The system of claim 1, wherein the conversion unit resides in a platform separate from the packet processor, the platform having separate configuration for managing data packets.

11. The system of claim 1, wherein the conversion unit includes an upstream transmission for transmitting all upstream channels delivered through the coaxial medium and a downstream transmission for transmitting all downstream channels delivered through the optical transceiver.

12. The system of claim 1, wherein the packet processor includes a master clock and the conversion unit includes a local clock that is synchronized to the master clock.

13. A method comprising:
receiving, at a conversion unit, a packet from a core, the packet being received from the core through an optical medium;
converting, at the conversion unit, the packet from a first format to a second format; and
transmitting the packet in the second format to one or more terminals through a coaxial medium.

14. The method of claim 13, wherein receiving the packet at the conversion unit includes receiving the packet at the conversion unit that is positioned outside the core.

15. The method of claim 13, wherein receiving the packet includes receiving the packet that is converted into an optical data stream and transmitted over the optical medium.

16. The method of claim 13, wherein receiving the packet at the conversion unit includes receiving the packet from a digital optical transmitter at the core for converting the packet into digital optical format prior to being received at the conversion unit.

17. The method of claim 13, wherein converting the packet includes converting the packet from an optical format to a radio frequency (RF) format.

18. The method of claim 17, further comprising modulating the packet in the RF format to generate a modulated RF signal,
wherein transmitting the packet in the second format includes transmitting the modulated RF signal to the coaxial medium.

19. A method comprising:
receiving, at a conversion unit, a modulated packet from a terminal through a coaxial medium;
converting, at the conversion unit, the modulated packet from a first format to a second format; and
transmitting the converted packet to a core through an optical medium.

20. The method of claim 19, wherein receiving the modulated packet includes receiving the modulated packet from a modulator at the terminal.

21. The method of claim 19, wherein converting the modulated packet includes converting the modulated packet from an RF format to an optical format.

22. The method of claim 19, wherein transmitting the converted packet is performed by a digital optical transmitter at the conversion unit.

23. The method of claim 19, wherein transmitting the converted packet includes transmitting the converted packet through an optical fiber to a digital optical receiver at the core to be converted into an RF format for processing by a packet processor.
